(19) United States
(12) Patent Application Publication
(10) Pub. No.: US 2007/0130111 A1
(43) Pub. Date: Jun. 7, 2007

(54) CLAIMS STATUS INTERROGATION AND TASK MANAGEMENT SYSTEM

(75) Inventors: Thomas Stoudt, Lansdale, PA (US); Sandra Ebel, Wynnewood, PA (US); Patricia Hewitt, West Chester, PA (US); Carl Roke, Exton, PA (US); Christian Nielson, Coronado, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS HEALTH SERVICES CORPORAT, MALVERN, PA (US)

(21) Appl. No.: 11/461,481

(22) Filed: Aug. 1, 2006

Related U.S. Application Data
(60) Provisional application No. 60/707,273, filed on Aug. 11, 2005.
(60) Provisional application No. 60/757,752, filed on Jan. 10, 2006.

(51) Int. Cl. G06F 17/30

(52) U.S. Cl. 707/2

(57) ABSTRACT

A system and method is provided for processing claim status queries and information concerning claims related to provisions of healthcare to patients. The system includes an input processor for receiving status query data including a plurality of different status queries concerning a plurality of different claims for healthcare services of a plurality of different patients. The status query data is formatted in a particular format employed by a corresponding particular healthcare organization. The system also includes a query translator for automatically translating the received status query data in a particular format into payer query data in an automatically selected payer query format of a payer organization responsible for paying at least a portion of individual claims. The system further includes a communication processor for communicating said payer query data to a payer organization.

### CROSS-REFERENCES TO RELATED APPLICATIONS

This application claims priority of U.S. Provisional Patent Application Ser. No. 60/707,278, filed on Aug. 11, 2005; and U.S. Provisional Patent Application Ser. No. 60/757,752, filed on Jan. 10, 2006.

### BACKGROUND OF THE INVENTION

1. Field of the Invention

The present invention relates to a system and method for processing healthcare claims, and more particularly, to a system and method for automating portions of a revenue transaction cycle for a healthcare provider.

2. Description of the Related Art

In order to receive compensation for services provided, healthcare entities must submit claims to a variety of payers. Once a claim is submitted, the processing time for the claim may be lengthy and the claim may be rejected for one or more reasons. To speed the processing of claims and receive payments associated with healthcare claims, it is advantageous for these healthcare entities to obtain the status associated with each claim as soon as a decision is made with regard to the claim

The Administrative Simplification Provisions of the Health Insurance Portability and Accountability Act passed by the U.S. Congress in 1996 promised benefits, such as reduced manual effort in revenue cycle activity. However, healthcare entities have yet to realize the promised benefits of the Administrative Simplification Provisions. Hence, the process for receiving payments for healthcare claims continues to be inefficient, and payments are frequently delayed. Due to this inefficiency, healthcare entities experience a high number accounts receivable days, reduced cash flow and high numbers of bad debt and write-offs. The cost of billing for healthcare services and processing of payments also continues to be high.

To provide more efficient methods of processing healthcare claims, existing systems support interactive claims status inquiries. For example, a current vendor of claims submission and remittance management systems provides products that handle transaction processing and allow healthcare entities to inquire and receive claim status updates from payers in a standardized electronic format. In addition, clearinghouses, such as ProxyMed™, NDC™, and WebMD™, also support claims status transaction processing. However, these existing systems offer limited functions regarding claim status processing. For example, once the claim status is obtained, there is no way of automatically updating receivable managements systems, used by the healthcare entity, to reflect the received status information.

Other existing systems use burdensome, slow screen scraping technology to simulate a user updating a patient accounting system, used by the healthcare entity. Such systems read a file of claim status responses and use a script executed on a computer system to navigate user interface screens of the patient accounting system, enter data in fields and submit updates to the patient accounting system. Yet still, other existing systems that are solely web-browser based typically allow users to enter claim status inquiries in a limited fashion, for example, one at a time. One existing system allows the user to upload and submit multiple claim status inquiries in one batch, but this system does not support automated processing of batches of claim status inquiries. Some existing systems also fail to support reporting for multi-entity organizations or reporting on claims status that correlates different revenue cycle transactions associated with an episode of care.

### SUMMARY OF THE INVENTION

The present invention overcomes the above-noted and other deficiencies of the prior art by providing a system and method for processing claim status queries and information concerning claims related to provisions of healthcare to patients. The system includes an input processor for receiving status query data including a plurality of different status queries concerning a plurality of different claims for healthcare services of a plurality of different patients. The status query data is formatted in a particular format employed by a corresponding particular healtcare organization. The system also includes a query translator for automatically translating the received status query data in a particular format into payer query data in an automatically selected payer query format of a payer organization responsible for paying at least a portion of individual claims. The system further includes a communication processor for communicating said payer query data to a payer organization.

Another embodiment of the invention is directed to a system and method for processing claim status queries and information. The system includes an input processor configured to receive status query data associated with at least one previously billed claim, wherein the status query data is used to check status of the at least one previously billed claim prior to an expected payment. The system also includes a query translator configured to automatically translate the received status query data in a predefined format supported by a payer entity responsible for paying at least a portion of the at least one previously billed claim. The system further includes a communication processor configured to communicate the translated status query data to the payer entity and to receive a claim status response from the payer entity, wherein the claim status response is formatted to a predefined format employed by an accounting system associated with a provider of service. The system also includes a connection unit to the accounting system, the connection unit being configured to trigger processing on an associated account within the accounting system upon receipt of the claim status response.

### BRIEF DESCRIPTION OF THE DRAWINGS

FIG. 1 illustrates a network that may be used to implement an embodiment of the present invention:

FIG. 1b further illustrates the claim status system and the patient accounting system;

FIG. 2 illustrates the steps implemented in an embodiment of the invention;

FIG. 3 illustrates the steps implemented in a web-enabled embodiment of the invention;

FIG. 4 illustrates the steps implemented in another embodiment of the invention;

FIG. 5 illustrates an embodiment of the request form that is used in embodiments of the present invention; and

FIG. 6 illustrates an embodiment of the response form that is used in embodiments of the present invention.

### DETAILED DESCRIPTION OF PREFERRED EMBODIMENTS

A system supports claim status reporting for multi-entity organizations by correlating different revenue cycle transactions associated with an episode of care.

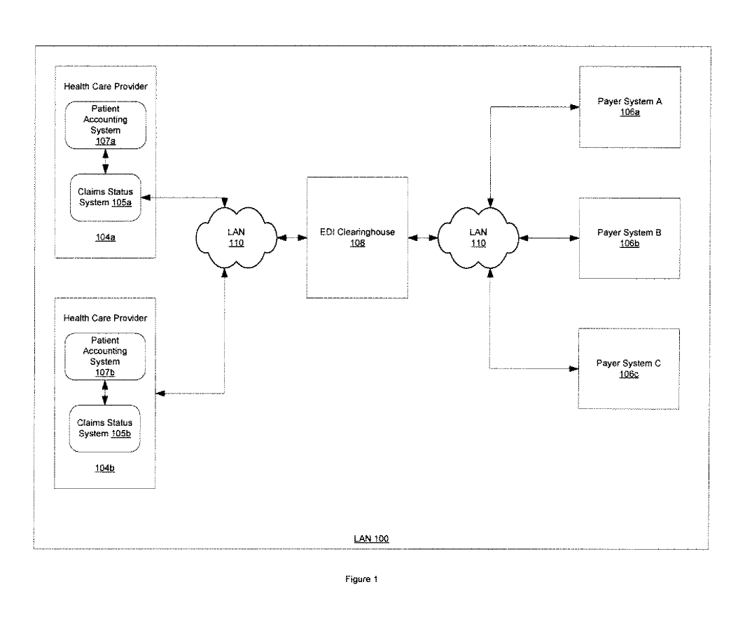

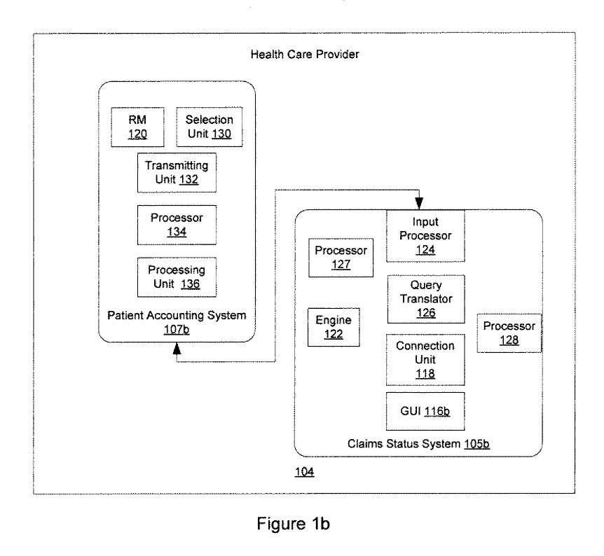

FIG. 1 illustrates a local area network (LAN) 100 that may be used to implement an embodiment of the present invention. LAN 100 includes business entities 104a-104b, 106a-106c and 108. Specifically, LAN 100 includes healthcare provider entities 104a and 104b, payer entities 106a-106c and electronic data interface (EDI) clearinghouse entity 108. Other quantities or combinations of entities may be used in other embodiments of the invention. Business entities on LAN 100 are preferably connected using communication links through the communications networks, illustrated as LAN 110. It should be apparent to those of ordinary skill in the art that other network topologies may be used.

According to an embodiment of the invention, some devices of LAN 100 may be web-enabled. For illustrative purposes, an embodiment of the invention uses applications executed on computer systems 105a/105b and 107a/107b to implement the invention described herein. Note, however, that any number of computer systems may be configured to implement the inventive method and that computer systems 105 and 107 are only used for exemplary purposes. Although computer systems are not illustrated in payer entities 106a-106c and EDI clearinghouse 108, computer systems are used in these business entities to communicate with systems 105 and 107. The computer systems used to execute the inventive system and method, for example, systems 105 and 107 and computer systems on payer entities 106a-106c and EDI clearinghouse 108, include electronic storage media, such as disks, for storing programming code and data structures used to implement the inventive method and outputs therefrom.

As illustrated in FIG. 1, each healthcare provider entity 104a/104b includes an associated patient accounting system 107a/107b and an associated claims status system 105a/105b. Patient accounting system 107 generates claim information and is the source of claims status inquires/requests transmitted from the associated claim status system 105 to a payer entity 106. A user of Cairns status system 105 may submit individual or multiple claim status inquires/requests to a payer entity 106 and view the response or responses associated with at least one previously billed claim. Healthcare provider entity 104a or 104b may communicate with payer entity 106 trough a third party 108, according to pre-existing third party agreement(s) that identify the terms and conditions between third party 108 and payer entity 106.

FIG. 1b further illustrates claim status system 105b and patient accounting system 107b, directed to processing claims related to provisions of healthcare. System 105b provides a graphical user interface 116b for the submission and viewing of the claim status inquiries/requests, by the user. System 105b also includes an input processor 124 configured to receive claim status query data for at least one previously billed claim for healthcare services. The claims status query data is used to check the status of the previously billed claim prior to an expected payment date. The input processor may be used to receive status query data including different status queries concerning different claims for healthcare services associated with different patients. The status query data is formatted in a particular format employed by a corresponding healthcare organization. System 105b also includes a query translator 126 which formats the status query data into claim status inquiry/request(s) by extracting required fields from the query data. Query translator is configured to automatically translate the extracted output into a predefined format supported by an appropriate payer entity 106 responsible for paying at least a portion of the previously billed claim. Query translator 126 is also configured to automatically translate received status query data in a particular format into payer query data in an automatically selected payer query format of a payer organization 106 responsible for paying at least a portion of individual claims.

System 105b then sends the claim status inquiry to the appropriate payer entity 106 using communication processor 128. Communication processor 128 is configured to communicate the translated status query data to payer entity 106 and to receive a claim status response from payer entity 106. The claim status response is formatted to a predefined format employed by accounting system 107b associated with a provider of service. System 105b also includes a validation processor 127 for verifying that the received status query data and/or payer query data complies with predetermined requirements for querying the payer organization. The predetermined requirements include at least one of health plan reimbursement conditions, health plan claim format requirements, requirement formula, reimbursement constraints and reimbursement computation procedure.

Upon receipt of a response from payer entity 106, query translator 126 automatically translate the query response data in a payer data format, received in response to communicating of the payer query data, into translated response data of an automatically selected response format of a particular healthcare organization. System 105b includes a connection unit 118 to a receivables management (RM) system 120 of system 107b. Connection unit 118 is configured to trigger processing on at least one associated account within receivables management system 120, upon receipt of the claims status response. For example, the claim status response may trigger processing within receivables management system 120 to update the status of a patient's account, prompt the user for additional information needed for successful claim processing, or re-prorate and re-bill a receivable to another payer.

The input processor is configured to support processing of batches of claim status inquiries and user managed batch submissions. The batch groupings are configured to include at least one payer per batch. A manual or batch claim status inquiry from system 105b and an associated response transaction from payer entity 106 enable healthcare provider entity 104b to check on the status of the claim inquiry before payment of an associated claim is expected by healthcare provider entity 104b, thereby accelerating feedback between healthcare provider entity 104b and payer 106. Such accelerated feedback enables users, at the healthcare entity, to correct and resubmit claims and shortens a payment cycle associated with the claim, thereby accelerating reimbursement.

The system complies with transaction, security, and privacy regulations issued by the Center for Medicare and Medicaid Services under the Health Insurance Portability and Accountability Act (HIPAA). HIPAA specifies standards for electronic transactions and code sets and defines requirements concerning the use of these standards by covered entities, such as health plans, healthcare clearinghouses, and healthcare providers. Specifically, the legislation mandates the exchange of this data as specified in the Accredited Standards Committee (ASC) X12N 276/277 (0040102093A1) for the Health Care Claims Status Request and Response. However, the system is not limited to such applications. The system supports automated processing of batches of claims status inquiries, based on parameters defined by healthcare provider 104b, in addition to user-managed batch submissions. An example of a parameter defined by healthcare provider 104b includes the number of days, after a claim is generated, within which a claim status inquiry is to be submitted. Server to server communication between components 104b, 106 and 108 is also supported to eliminate sole reliance on web-based applications. Database logging, which also provides the option of creating new inquiries from previous ones, is also supported in an embodiment of the invention. In addition, batching groups are not limited to one payer per batch, Extensive searching and reporting capabilities based on claims status response codes are also supported. Examples of claim status response codes include a code for specifying if more information is required before the claim status request can be processed, a code for specifying if other attachments, such as emergency room notes, are required, or a code for specifying if a service is denied. Access control lists may be created by the provider so that access to view information is limited to approved users. User interface 116b of system 105b also enables the user to cancel a request for a real-time response.

Accounting system 107b may include a selection unit 130 configured to automatically select status query data associated with at least one previously billed claim, The status query data is used to check status of at least one previously billed claim prior to an expected payment. Accounting system 107b may also include a transmitting unit 132 configured to transmit the status query data for submission to a payer entity. The status query data is formatted to a predefined format employed by the payer entity responsible for paying at least a portion of the one previously billed claim. Accounting system 107b may further include a communication processor 134 configured to receive a claim status response from the payer entity and a processing unit 136 configured to map messages in the claim status response to associated accounts. The claim status response is formatted to a predefined format employed by the associated accounting system. Receipt of the claim status response messages triggers processing on an associated account within the accounting system. Selection unit 130 is configured to qualify associated accounts for appropriate follow-up lists and is configured to include rules for specifying when to initiate claim status requests from the accounting system. Selection unit 130 is also configured to support automated processing of batches of claim status inquiries, wherein batch groupings are configured to include multiple payers per batch. Processing unit 136 is configured to trigger processing including at least one of initiating a revenue cycle activity, updating a status of an account, prompting a user for additional information, generating of reports, or generating follow-up information.

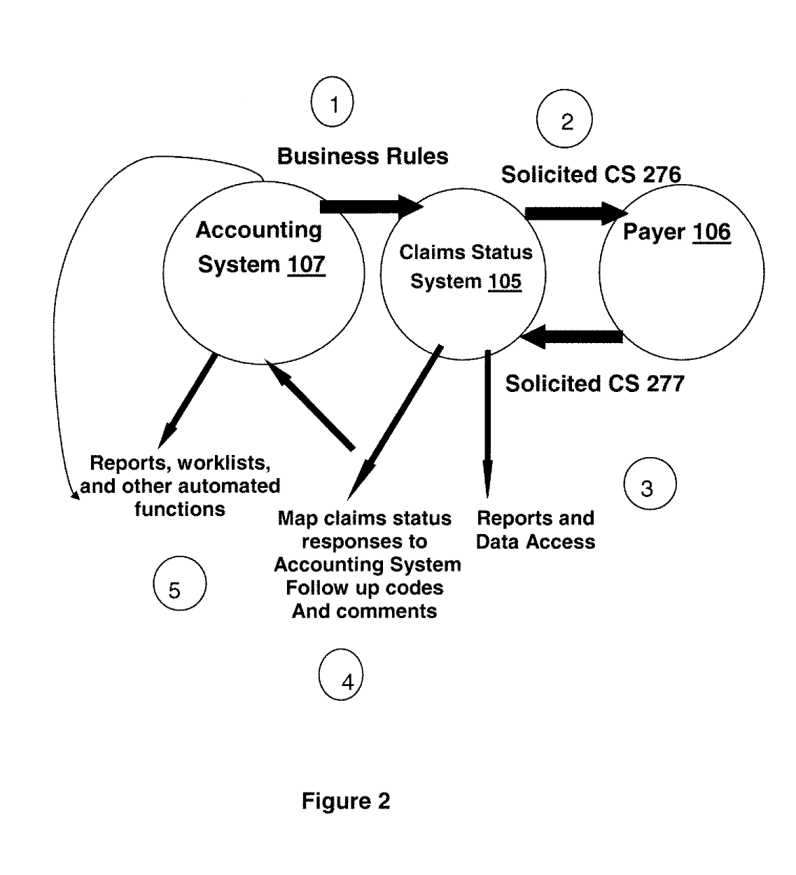

FIG. 2 illustrates the steps implemented in an embodiment of the invention. In Step 1, healthcare provider 104b creates business rules that specify when to initiate a claim status request/inquiry via accounting system 107b. For example, healthcare provider 104b creates a business rule to define the number of days, after an associated claim is generated, within which a claim status inquiry is to be submitted. In Step 2, input processor 124 of system 105b receives claim status query data for at least one claim for healthcare services and query translator 126 formats the data into claim status inquiry/request(s) by extracting required fields and transforming the extracted output into an ASC X12N 276 transaction. System 105b sends the claim status inquiry to an appropriate payer entity 106 using communication processor 128. In Step 3, payer entity 106 processes the claim status request, according to external rules defined by payer entity 106, and sends claim status response messages to claim status system 105b. The claim status response messages are formatted in accordance with ASC X12N 277 rules. In Step 4, claim status system 105b reformats the claim status response messages into data that is uploaded to accounting system 107b, using connection unit 118. Claim status system 105b also generates reports. In Step 5, based on the claim status response information, the connection unit is configured to trigger processing in accounting system 107b, including initiating other revenue cycle activities, such as reports, work lists, task lists or automated functions such as re-bills, secondary bills and balance transfers. As is known to one skilled in the art, a work list comprises tasks (and a task list) to be performed by a worker or device that may involve, for example, a group of claims that require follow-up. A task list may include activities that need to be performed by a user Such tasks may include a re-bill involving re-billing a claim to a primary insurer, secondary billing involving billing a claim to a secondary insurer and a balance transfer involving transferring a claim balance from a primary insurer to a secondary insurer or to the patient.

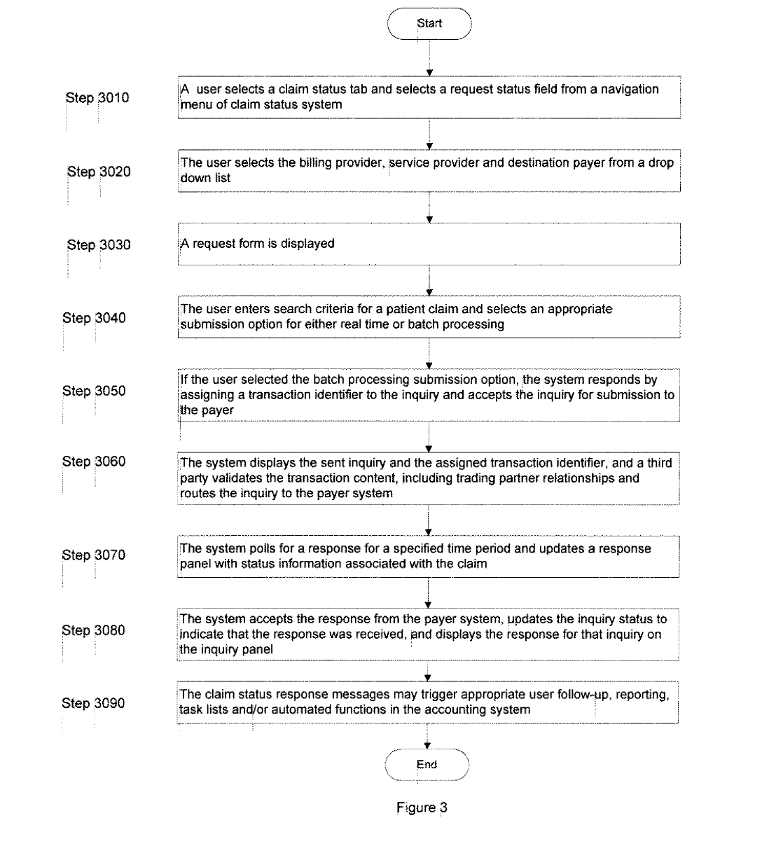

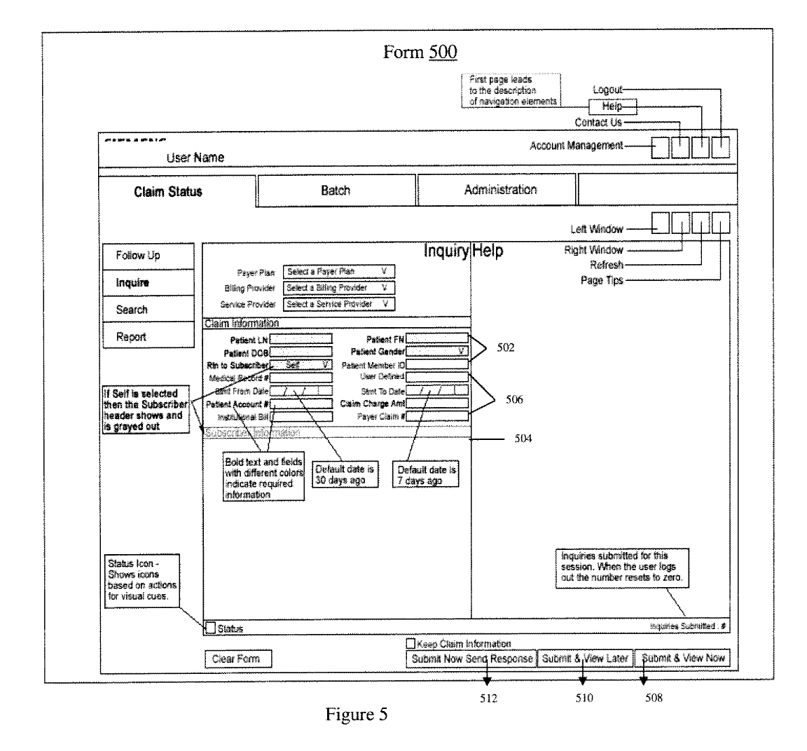

FIG. 3 illustrates the steps implemented in a web-enabled embodiment of the invention. It should be apparent to one skilled in the art that other non-web based embodiments are also within the scope of the present invention. In Step 3010, a user selects a claim status tab and selects a request status field from a navigation menu provided by graphical user interface 116b. System 105b then displays a request form, such as an “Add Claim Status Request” form that enables the end user to request a claim status inquiry through graphical user interface 116b. The user may either enter or select information on the request form that identifies a requester and prompts for a name of a billing provider, a service provider and a payer. In Step 3020, the user selects the billing provider of a service such as a hospital, a service provider such as a doctor, and destination payer from a drop down list. In Step 3030, a request form, illustrated in FIG. 5 as form 500, is displayed. Request form 500, described in detail below, includes input fields for required and optional query data that is accepted by the payer Request form 500 also includes inquiry submission prompts that are associated with the payer. In Step 3040, the user enters search criteria for a patient claim and selects an appropriate submission option for either real time or batch processing. In the batch processing option, the user groups claims that are to be included in a claim status request.

If the user selects the batch processing submission option, in Step 3050, system 105b responds by assigning a transaction identifier, to each request, in the claim status inquiry and accepts the inquiry for submission to payer entity 106. For example, system 105b assigns the transaction identifier to each request and ensures that the required data fields are populated in each request to create an ASC X12N 276 formatted record. System 105b displays the sent inquiry and the assigned transaction identifier and sends the transaction to third party 108. In Step 3060, third party 108 validates that the transaction content is in compliance with ASC X12N 276 standard. Third party 108 validates wading partner relationships, between third party 108 and payer entity 106, according to pre-existing third party agreement(s) tat identify the terms and conditions between third party 108 and payer entity 106. Third party 108 then routes the claim status inquiry to payer entity 106 based on network connections, such as TCP IP or dial up connections.

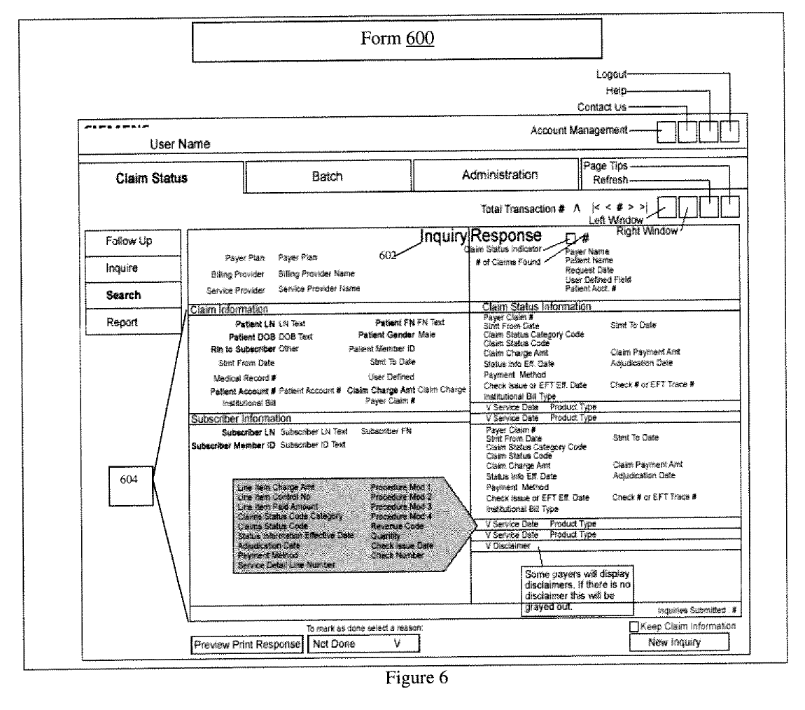

In Step 3070, system 105b polls for a response for a specified time period and updates a response panel with status information associated with the claim. The communication processor of system 105b is configured to poll for the claim status response from the payer device for a specified time period. In Step 3080, system 105b accepts the response from payer entity 106, updates the inquiry status to indicate that the response was received, and displays the response for that inquiry on the response panel, illustrated as FIG. 6. Even though the response record is in compliance with ASC X12N 277 standard, the response information may vary according to payer entity 106 because different payers may use different data and claim status codes. In one example, one payer may include all fields relating to the claim status information in the response message, while another payer may include a subset of fields relating to the claim status information. In another example, two payers may use different claim status codes to indicate that additional information is needed to complete processing of the claim status request message. For the second example, to process the response messages from the two payers, both claim status codes need to be defined in accounting system 107b. In Step 3090, the claim status response messages may trigger appropriate user follow-up, reporting, task lists and/or automated functions, for example balance transfer and secondary claim generation, in accounting system 107b.

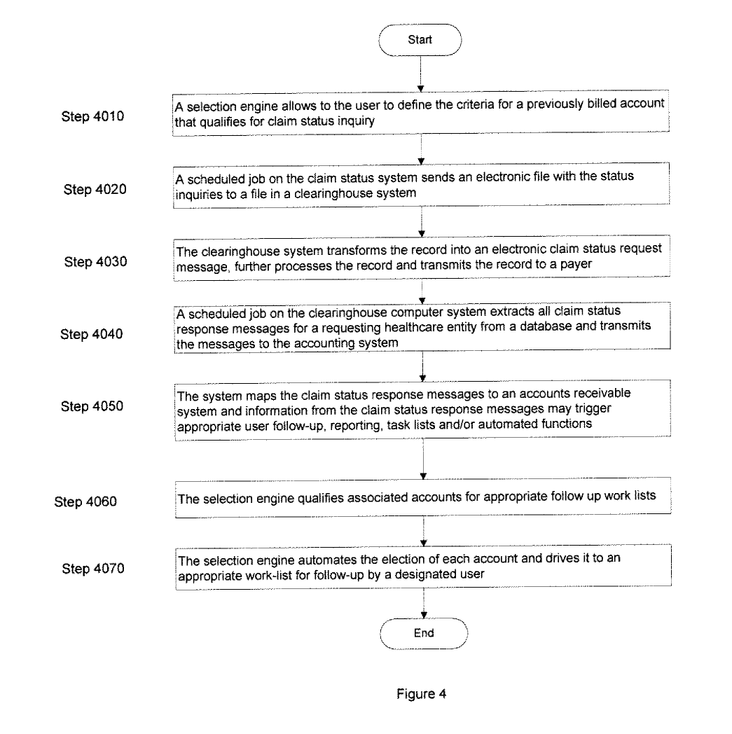

FIG. 4 illustrates the steps implemented in another embodiment of the invention. Accounts are automatically selected for a claim status inquiry via a selection engine 122 tat processes data in accounting system files created by healthcare provider 104b. For example, the accounts may be selected from a master file or database in accounting system 107b based on rules defined by the provider or based on a type of claim defined by healthcare provider 104b. As noted above, an example of a rule defined by healthcare provider 104b includes a rule that specifies the number of days, after an associated claim is generated, before a status inquiry is to be initiated. In Step 4010, selection engine 122 allows a user to define the rules/criteria for a previously billed account that qualifies for claim status inquiry. In one example, the criteria might identify accounts associated with a specific payer that were billed a predefined number of days, for example 3 days, before the claim status inquiry is to be initiated and that have no posted insurance payments. In another example, the criteria might identify accounts for a specific payer that provided a particular claim status category code on previous claim status responses. According to this criterion, the previous claim status response needs to be received a predefined number of days before the claim status inquiry is to be initiated and claim status response needs to include a user posted activity code, indicating that a second status inquiry is needed.

Upon creating criteria for selection engine 122, in Step 4020, a scheduled function on system 105b initiates sending of an electronic file with the status inquiries to a file in clearinghouse entity 108 based on network connections and hardware used by healthcare provider 104b and clearinghouse entity 108. In Step 4030, for each record in the file, clearinghouse entity 108 transforms the record into an electronic claim status request message, by extracting required information from the record and transforming the record to an ASC X12N 276 formatted record. Clearinghouse entity 108 also indexes and stores the claim status request message in a database and determines a payer entity 106, the network address, and communication protocol for a receiver system, based on predefined network configuration parameters Clearinghouse entity 108 then sends the message over a computer network to the receiver system, for example payer entity 106a

Thereafter, clearinghouse entity 108 receives a claim status response message from the receiver system and indexes and stores the claim status response message in a database. At a scheduled time, in Step 4040, a scheduled activity executing on the clearinghouse computer system extracts claim status response messages for a requesting healthcare entity, for example 104b, from the database, determines an appropriate format for the requesting healthcare entity 104b, in accordance with ASC X12N 277 and rules identified by healthcare entity 104b on the type of records to be returned. Clearinghouse entity 104b transforms the claims status response messages into that format, writes claim status response messages, according to a computer program protocol Specifically, the clearinghouse entity in response to computer instruction writes the claim status response messages to the electronic data file. Clearinghouse entity 108 also determines the network address and communication protocol for healthcare entity 104b, based on pre-existing network configuration parameters, and sends the electronic data file of claim status response messages to the requesting healthcare entity 104b system, for example system 105b. It should be apparent to one skilled in the art that the tasks performed by clearinghouse entity 108 may also be performed by system 105b or another system implementing the invention.

In Step 4050, when the file of claim status response messages is returned to system 105b, system 105b maps the claim status response messages to an accounts receivable system 120 and information, such as codes, from the claim status response messages may trigger appropriate user follow-up, reporting, task lists and/or automated functions, such as re-bill, secondary bills and balance transfers. Specifically, claim status category codes and/or status response codes received in the response messages are codified within accounting system 107b, thus allowing a user to define attributes via selection engine 122. For example, in Step 4060, selection engine 122 may use codes in the claim status response messages to select associated accounts for appropriate follow up work list tasks.

In Step 4070, selection engine 122 automates the selection of each account and groups claims that require follow-up in an appropriate work-list for follow-up by a designated user, for example a receivables clerk. In one example, the user might set up a work list for a specific payer, where account responses include a claim status category code, for example, R3 which indicates request for additional information. Based on this work list qualification criterion, upon receiving the claim status response messages, system 107b automatically routes a follow up work list that is defined to include accounts from the predefined payer where additional information is needed. This enables the user assigned to review each case in the work list to send the requested additional information through system 104b for further processing of the associated claims. In another example, the user might set up another work list for a specific payer, where account responses include a claim status category code, for example P2 which indicates that the claim is under review. Based on this work list qualification criterion, upon receiving claim status response messages, system 107b selects and groups that appropriate accounts from the response message and routes a follow up work list that is defined to include pending accounts from the specific payer to the user through a programming protocol. Upon receiving the work list, the user reviews the detailed claims status code for each account to determine whether a second follow up inquiry should be sent. An activity code placed on the account may allow the subsequent inquiry to be automated.

Embodiments of the system therefore communicate the claim status responses back to provider accounting system 107b before payment of an associated claim is expected, thereby triggering appropriate follow up, reporting, task lists and/or automated functions. As such, embodiments of the system, advantageously enables accounting system 107b to use the response data to expedite overall revenue cycle workflow by allowing the user to request claim status inquiry before payment of an associated claim is expected.

Graphical user interface 116 which includes a plurality of fields for entering at least one claim status request information and inquiry submission prompts that are associated with the payer device. FIG. 5 illustrates an embodiment of the request form 500 that is used in embodiments of the present invention On form 500, for each record, patient information 502, such as a patient last name (LN), the patient first name (FN), the patient Rel-to-Subscriber, the patient date of birth, the patient gender, the claim charge amount, and patient account number are required fields that may be filled by the user. Each record also includes the subscriber information 504 and, if the subscriber is not the same as the patient, the subscriber LN, the subscriber member identifier, the service date are required fields that may be filled by the user. Each record also includes product/service ID type, service identifier code and line item charge amount that are required fields that may be filled by the user. For each record, optional information 506, such as the patient member identifier, the statement from date, statement to date, payer claim number institutional bill type, medical record number, subscriber FN, line item control number, procedure Mod 1-4, revenue code and the quantity fields may also be filled by the user. Upon entering the required fields in form 500, if the payer supports real time inquiry and response, the user may select a “Submit and View Response Now” field 508, a “Submit Now View Response Later” field 510, or a “Submit Now and Send Response” field 512. If the payer supports batch inquiry, the user may select either “Submit Now View Response Later” field 510, or “Submit Now and Send Response” field 512,

FIG. 6 illustrates an embodiment of the response form 600. A claim status response message that is submitted to system 107b includes response summary 602 and a claim status information section 604. The response summary 602 may include fields for a payer, patient name, request date, whether nor not a claim(s) is found, the number of claims found, the patient account number and a user field which also serves as an inquiry trace number. A claim status information section 604 includes claim status data, if a claim is identified on the response summary page. If more than one claim was indicated on the response summary, a slider is displayed for each claim, where the title on the slider provides summary information of the content. The claim status information 602 section also includes fields for a payer claim number, dates of the statement, a claim status code category, claim status code(s), a claim charge amount, a claim payment amount, a status information effective date, an adjudication date, a payment method code, a check issue date or electronic funds transfer effective date, and a check number or electronic funds transfer trace number. For the claim status code category and claim status code and the payment method code, system 107b displays the appropriate claim status message text, if prompted by the user.

The system displays a service line detailed slider for each claim that has status information. The system displays the slider below the claim details for each associated claim. When the user selects the slider, a table of service line detail appears. Each service is illustrated as a row in the table. If the claim is associated with professional services, the system displays the professional service line detail. If the claim is for institutional services, the system displays the institutional service line detail. Therefore, a claim status response record may include zero to many service detail lines and some combination of a service data, a product/service identifier type and service identifier code, a line item charge amount, a line item control number, procedure mod 1-4, a revenue code, a quality field, a line item paid amount, a claim status code category, a claim status code, a status information effective date, an adjudication date, a payment method, a check issue data, a check number and a service detail line number.

An executable application as used herein includes code or machine readable instruction for implementing predetermined functions including those of an operating system, healthcare information system or other information processing system, for example, in response user command or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. As used herein, a processor includes any one or combination of, hardware, firmware, and/or software. A processor acts upon information by manipulating, analyzing, modifying, converting or transmitting information for use by an executable procedure or an information device, and/or by routing the information to an output device. A processor may use or include the capabilities of a controller or microprocessor, for example. A display processor or generator is a known element including electronic circuitry or software or a combination of both for generating display images or portions thereof. A user interface includes one or more display images enabling user interaction with a processor or other device.

It should be appreciated by one skilled in art, that the system may be utilized in any device that implements the a system that supports claims status reporting for multi-entity organizations, wherein the reporting correlates different revenue cycle transactions associated with an episode of care. The foregoing description has been directed to specific embodiments of this invention. Other variations and modifications may be made to the described embodiments, with the attainment of some or all of their advantages. Therefore, it is the object of the appended claims to cover all such variations and modifications as come within the true spirit and scope of the invention.

In the claims:

1. A system for processing claim status queries and information concerning claims related to provisions of healthcare to patients, comprising:
an input processor for receiving status query data comprising a plurality of different status queries concerning a plurality of different claims for healthcare services of a plurality of different patients, said status query data being formatted in a particular format employed by a corresponding particular healthcare organization;
a query translator for automatically translating said received status query data in a particular format into payer query data in an automatically selected payer query format of a payer organization responsible for paying at least a portion of individual claims; and
a communication processor for communicating said payer query data to a payer organization.

2. The system according to claim 1, wherein
said query translator automatically translates query response data in a payer data format, received in response to said communication of said payer query data, into translated response data of an automatically selected response format of said particular healthcare organization, and
said communication processor communicates said translated response data to said particular healthcare organization.

3. The system according to claim 1, including a validation processor for verifying at least one of, (a) said received status query data and (b) said payer query data, complies with predetermined requirements for querying said payer organization.

4. The system according to claim 3, wherein said predetermined requirements include at least one of, (a) health plan reimbursement conditions, (b) health plan claim format requirements, (c) a reimbursement formula, (d) reimbursement constraints and (e) reimbursement computation procedure.

5. A system for processing claim status queries and information, comprising:
an input processor configured to receive status query data associated with at least one previously billed claim, wherein the status query data is used to check status of the at least one previously billed claim prior to an expected payment;
a query translator configured to automatically translate the received status query data in a predefined format supported by a payer entity responsible for paying at least a portion of the at least one previously billed claim;
a communication processor configured to communicate the translated status query data to the payer entity and to receive a claim status response from the payer entity, wherein the claim status response is formatted to a predefined format employed by an accounting system associated with a provider of service; and
a connection unit to the accounting system, the connection unit being configured to trigger processing on an associated account within the accounting system upon receipt of the claim status response.

6. The system of claim 5, wherein the system is directed to processing of claims related to provision of healthcare.

7. The system of claim 5, wherein the input processor is configured to support automated processing of batches of claim status inquiries and user managed batch submissions, wherein batch groupings are configured to include at least one payer per batch.

8. The system of claim 5, further comprising a graphical user interface for submitting and viewing of the at least one claim status request.

9. The system of claim 8, wherein the graphical user interfaces comprises a plurality of fields for entering the at least one claim status request information and inquiry submission prompts that are associated with the payer device.

10. The system of claim 9, wherein when the inquiry submission prompt for a batch processing option is selected, a transaction identifier is assigned to the claim status request.

11. The system of claim 5, wherein the communication processor is configured to poll for the claim status response from the payer device for a specified time period.

12. The system of claim 1, wherein the connection unit is configured to trigger processing comprising at least one of initiating a revenue cycle activity, updating a status of an account, prompting a user for additional information, generating of reports, or generating follow-up information.

13. An accounting system associated with a provider of service for processing claim status queries and information, the system comprising:
a selection unit configured to automatically select status query data associated with at least one previously billed claim, wherein the status query data is used to check status of the at least one previously billed claim prior to an expected payment;
a transmitting unit configured to transmit the status query data for submission to a payer entity, wherein status query data is formatted to a predefined format employed by the payer entity responsible for paying at least a portion of the at least one previously billed claim;
a communication processor configured to receive a claim status response from the payer entity, wherein the claim status response is formatted to a predefined format employed by the associated accounting system; and
a processing unit configured to map messages in the claim status response to associated accounts, wherein receipt of the claim status response messages triggers processing on an associated account within the accounting system.

14. The system of claim 13, wherein the selection unit is configured to qualify associated accounts for appropriate follow-up lists.

15. The system of claim 13, wherein the selection unit is configured to include rules for specifying when to initiate claim status requests from the accounting system, wherein the claim status requests are associated with claims related to provision of healthcare services.

16. The system of claim 13, wherein the selection unit is configured to support automated processing of batches of claim status inquiries, wherein batch groupings are configured to include multiple payers per batch.

17. The system of claim 13, wherein the processing unit is configured to trigger processing comprising at least one of initiating a revenue cycle activity, updating a status of an account, prompting a user for additional information, generating of reports, or generating follow-up information.

18. A method of processing claim status queries and information, the method comprising:
receiving status query data associated with at least one previously billed claim, wherein the status query data is used to check status of the at least one previously billed claim prior to an expected payment;
translating the received status query data in a predefined format supported by a payer entity responsible for paying at least a portion of the at least one previously billed claim;
communicating the translated status query data to the payer entity;
receiving a claim status response from the payer entity, wherein the claim status response is formatted to a predefined format employed by an accounting system associated with a provider of service; and
triggering a process on an associated account within the accounting system upon receipt of the claim status response.

19. The method of claim 18, wherein the translating step further comprises validating transaction contents of the at least one claim status request, wherein the at least one claim request is associated with provision of healthcare services.

20. The method of claim 18, wherein the receiving step further comprises supporting automated processing of batches of claim status inquiries and user managed batch submissions, wherein batch groupings are configured to include at least one payer per batch.

21. The method of claim 18, wherein the triggering a process step further comprises triggering a process comprising at least one of initiating a revenue cycle activity, updating a status of an account, prompting a user for additional information, generating of reports, or generating follow-up information.

22. A method in an accounting system associated with a provider of service for processing claim status queries and information, the method comprising:
selecting status query data associated with at least one previously billed claim, wherein the status query data is used to check status of the at least one previously billed claim prior to an expected payment;
transmitting the status query data for submission to a payer entity, wherein the status query data is formatted to a predefined format employed by the payer entity responsible for paying at least a portion of the at least one previously billed claim;
receiving a claim status response from the payer entity, wherein the claim status response is formatted to a predefined format employed by the associated accounting system; and
mapping messages in the claim status response to associated accounts, wherein receipt of the claim status response messages triggers processing on the associated accounts within the accounting system.

23. The method of claim 22, wherein the selecting step further comprises qualifying associated accounts for appropriate follow-up lists.

24. The method of claim 22, wherein the selecting step further comprises specifying when to initiate the at least one claim status request from the accounting system, wherein the at least one claim request is associated with provision of healthcare services.

25. The method of claim 22, wherein the selecting step further comprises supporting automated processing of batches of claim status inquiries, wherein batch groupings are configured to include multiple payers per batch.

26. The method of claim 22, wherein the mapping step further comprises triggering a process comprising at least one of initiating a revenue cycle activity, updating a status of an account, prompting a user for additional information, generating of reports, or generating follow-up information.

27. An apparatus, comprising:
receiving means for receiving status query data associated with at least one previously billed claim, wherein the status query data is used to check status of the at least one previously billed claim prior to an expected payment;
translating means for translating the received status query data in a predefined format supported by a payer entity responsible for paying at least a portion of the at least one previously billed claim;
communicating means for communicating the translated status query data to the payer entity;
receiving means for receiving a claim status response from the payer entity, wherein the claim status response is formatted to a predefined format employed by an accounting system associated with a provider of service; and
triggering means for triggering a process on an associated account within the accounting system upon receipt of the claim status response.

28. An apparatus, comprising:
selecting means for selecting status query data associated with at least one previously billed claim, wherein the status query data is used to check status of the at least one previously billed claim prior to an expected payment;
transmitting means for transmitting the status query data for submission to a payer entity, wherein the status query data is formatted to a predefined format employed by the payer entity responsible for paying at least a portion of the at least one previously billed claim;
receiving means for receiving a claim status response from the payer entity, wherein the claim status response is formatted to a predefined format employed by the associated accounting system; and
mapping means for mapping messages in the claim status response to associated accounts, wherein receipt of the claim status response messages triggers processing on the associated account within the accounting system.

29. A computer program embodied on a computer readable medium, the computer program comprising instruction for implementing the steps of:
receiving status query data associated with at least one previously billed claim, wherein the status query data is used to check status of the at least one previously billed claim prior to an expected payment;
translating the received status query data in a predefined format supported by a payer entity responsible for paying at least a portion of the at least one previously billed claim;
communicating the translated status query data to the payer entity;
receiving a claim status response from the payer entity, wherein the claim status response is formatted to a predefined format employed by an accounting system associated with a provider of service; and
triggering a process on an associated account within the accounting system upon receipt of the claim status response.

30. A graphical user interface of a computer program embodied on a computer readable medium, the graphical user interface comprising:
a plurality of fields for submission and viewing of status query data associated with at least one previously billed claim and inquiry submission prompts, wherein the status query data is used to check status of the at least one previously billed claim prior to an expected payment and wherein upon entering the status query data, means associated with the graphical user interface translate the received status query data in a predefined format supported by a payer entity responsible for paying at least a portion of the at least one previously billed claim and communicate the translated status query data to the payer entity;
wherein at least one of the plurality of fields is associated with receiving means for receiving a claim status response from the payer entity, wherein the claim status response is formatted to a predefined format employed by an accounting system associated with a provider of service; and
wherein receipt of the claim status response triggers a process on an associated account within the accounting system.

31. The graphical user interface of claim 31, wherein when the inquiry submission prompt is a batch processing option, the graphical user interface further includes means for assigning a transaction identifier to the claim status request and for displaying the assigned transaction identifier.
